(19) United States
(12) Patent Application Publication
(10) Pub. No.: US 2022/0165119 A1
(43) Pub. Date: May 26, 2022

(54) METHOD OF PROVIDING USER COMPARISON DATA

(71) Applicant: AdrenalineIP, Washington, DC (US)

(72) Inventors: Casey Alexander HUKE, Washington, DC (US); John CRONIN, Jericho, VT (US); Joseph W. BEYERS, Saratoga, CA (US); Michael D'ANDREA, Burlington, VT (US)

(73) Assignee: AdrenalineIP, Washington, DC (US)

(21) Appl. No.: 17/533,543

(22) Filed: Nov. 23, 2021

Related U.S. Application Data
(60) Provisional application No. 63/117,113, filed on Nov. 23, 2020.

(51) Int. Cl. G07F 17/32

(52) U.S. Cl. CPC G07F 17/323; G07F 17/3211; G07F 17/3288

(57) ABSTRACT

A method of informing a user of a sports betting application of his or her performance compared to the user's friends or other users (e.g., this user just fell behind his friend, or this user is doing the best out of his group of friends).

### CROSS-REFERENCE TO RELATED APPLICATIONS

The present patent application claims benefit and priority to U.S. Provisional Patent Application No. 63/117,113 entitled “METHOD OF PROVIDING USER COMPARISON DATA” filed on Nov. 23, 2020 which is hereby incorporated by reference into the present disclosure.

### FIELD

The embodiments are generally related to wagering on live sporting events.

### BACKGROUND

Watching and wagering on sports events are activities that many people enjoy with others. However, gathering people physically together can be inconvenient at best and dangerous at worst due to circumstances such as a pandemic.

Without gathering with friends or family, many people may not participate in sports wagering, may reduce the amount they wager, or may not watch major sporting events at all.

Online group calls or chat may be one way of dealing with these issues but communicating can quickly become hectic and does not accurately track the wagers being placed.

### SUMMARY

Methods for providing user comparison data in wagering. In one embodiment, a method for comparing user data in a sports wagering application can include storing wagers from a sports wagering application in a database; storing one or more contacts for each of a plurality of users of the sports wagering application in the database; polling the database for wagers made by the plurality of users; comparing metrics of wagers of at least a first user and at least a second user among the plurality of users; assigning a rank to the at least first user and the at least second user on a leaderboard based on the comparison of metrics; and notifying the at least first user of a change in rank on the leaderboard.

In another embodiment, a method for providing a leaderboard for a live action game wagering system can include displaying a wagering application; displaying one or more contacts of a user that use the wagering application; displaying one or more wagers associated with a live action game; displaying results of a wager placed by the user in the wagering application; and displaying a leaderboard, where the leaderboard is determined by at least the results of the wager placed by the user and results of a wager placed by at least one or more of the contacts.

### BRIEF DESCRIPTIONS OF THE DRAWINGS

The accompanying drawings illustrate various embodiments of systems, methods, and various other aspects of the embodiments. Any person having ordinary skill in the art will appreciate that the illustrated element boundaries (e.g., boxes, groups of boxes, or other shapes) in the figures represent an example of the boundaries. It may be understood that, in some examples, one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 illustrates a user data comparison system, according to an embodiment.

FIG. 2 illustrates a base module, according to an embodiment.

FIG. 3 illustrates a contact module, according to an embodiment.

FIG. 4 illustrates a leaderboard module, according to an embodiment.

FIG. 5 illustrates a contact database, according to an embodiment.

### DETAILED DESCRIPTION

Aspects of the present invention are disclosed in the following description and related figures directed to specific embodiments of the invention. Those of ordinary skill in the art will recognize that alternate embodiments may be devised without departing from the spirit or the scope of the claims. Additionally, well-known elements of exemplary embodiments of the invention will not be described in detail or will be omitted so as not to obscure the relevant details of the invention.

As used herein, the word exemplary means serving as an example, instance or illustration. The embodiments described herein are not limiting, but rather are exemplary only. It should be understood that the described embodiments are not necessarily to be construed as preferred or advantageous over other embodiments. Moreover, the terms embodiments of the invention, embodiments or invention do not require that all embodiments of the invention include the discussed feature, advantage, or mode of operation.

Further, many of the embodiments described herein are described in terms of sequences of actions to be performed by, for example, elements of a computing device. It should be recognized by those skilled in the art that the various sequence of actions described herein can be performed by specific circuits (e.g., application specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in a number of different forms, all of which have been contemplated to be within the scope of the claimed subject matter. In addition, for each of the embodiments described herein, the corresponding form of any such embodiments may be described herein as, for example, a computer configured to perform the described action.

With respect to the embodiments, a summary of terminology used herein is provided.

An action refers to a specific play or specific movement in a sporting event. For example, an action may determine which players were involved during a sporting event. In some embodiments, an action may be a throw, shot, pass, swing, kick, hit, performed by a participant in a sporting event. In some embodiments, an action may be a strategic decision made by a participant in the sporting event such as a player, coach, management, etc. In some embodiments, an action may be a penalty, foul, or type of infraction occurring in a sporting event. In some embodiments, an action may include the participants of the sporting event. In some embodiments, an action may include beginning events of sporting event, for example opening tips, coin flips, opening pitch, national anthem singers, etc. In some embodiments, a sporting event may be football, hockey, basketball, baseball, golf, tennis, soccer, cricket, rugby, MMA, boxing, swimming, skiing, snowboarding, horse racing, car racing, boat racing, cycling, wrestling, Olympic sport, eSports, etc. Actions can be integrated into the embodiments in a variety of manners.

A “bet” or “wager” is to risk something, usually a sum of money, against someone else's or an entity on the basis of the outcome of a future event, such as the results of a game or event. It may be understood that non-monetary items may be the subject of a “bet” or “wager” as well, such as points or anything else that can be quantified for a “bet” or “wager”. A bettor refers to a person who bets or wagers. A bettor may also be referred to as a user, client, or participant throughout the present invention. A “bet” or “wager” could be made for obtaining or risking a coupon or some enhancements to the sporting event, such as better seats, VIP treatment, etc. A “bet” or “wager” can be done for certain amount or for a future time. A “bet” or “wager” can be done for being able to answer a question correctly. A “bet” or “wager” can be done within a certain period of time. A “bet” or “wager” can be integrated into the embodiments in a variety of manners.

A “book” or “sportsbook” refers to a physical establishment that accepts bets on the outcome of sporting events. A “book” or “sportsbook” system enables a human working with a computer to interact, according to set of both implicit and explicit rules, in an electronically powered domain for the purpose of placing bets on the outcome of sporting event. An added game refers to an event not part of the typical menu of wagering offerings, often posted as an accommodation to patrons. A “book” or “sportsbook” can be integrated into the embodiments in a variety of manners.

To “buy points” means a player pays an additional price (more money) to receive a half-point or more in the player's favor on a point spread game. Buying points means you can move a point spread, for example up to two points in your favor. “Buy points” can be integrated into the embodiments in a variety of manners.

The “price” refers to the odds or point spread of an event. To “take the price” means betting the underdog and receiving its advantage in the point spread. “Price” can be integrated into the embodiments in a variety of manners.

“No action” means a wager in which no money is lost or won, and the original bet amount is refunded. “No action” can be integrated into the embodiments in a variety of manners.

The “sides” are the two teams or individuals participating in an event: the underdog and the favorite. The term “favorite” refers to the team considered most likely to win an event or game. The “chalk” refers to a favorite, usually a heavy favorite. Bettors who like to bet big favorites are referred to “chalk eaters” (often a derogatory term). An event or game in which the sports book has reduced its betting limits, usually because of weather or the uncertain status of injured players is referred to as a “circled game.” “Laying the points or price” means betting the favorite by giving up points. The term “dog” or “underdog” refers to the team perceived to be most likely to lose an event or game. A “longshot” also refers to a team perceived to be unlikely to win an event or game. “Sides”, “favorite”, “chalk”, “circled game”, “laying the points price”, “dog” and “underdog” can be integrated into the embodiments in a variety of manners.

The “money line” refers to the odds expressed in terms of money. With money odds, whenever there is a minus (−) the player “lays” or is “laying” that amount to win (for example $100); where there is a plus (+) the player wins that amount for every $100 wagered. A “straight bet” refers to an individual wager on a game or event that will be determined by a point spread or money line. The term “straight-up” means winning the game without any regard to the “point spread”; a “money-line” bet. “Money line”, “straight bet”, “straight-up” can be integrated into the embodiments in a variety of manners.

The “line” refers to the current odds or point spread on a particular event or game. The “point spread” refers to the margin of points in which the favored team must win an event by to “cover the spread.” To “cover” means winning by more than the “point spread”. A handicap of the “point spread” value is given to the favorite team so bettors can choose sides at equal odds. “Cover the spread” means that a favorite win an event with the handicap considered or the underdog wins with additional points. To “push” refers to when the event or game ends with no winner or loser for wagering purposes, a tie for wagering purposes. A “tie” is a wager in which no money is lost or won because the teams' scores were equal to the number of points in the given “point spread”. The “opening line” means the earliest line posted for a particular sporting event or game. The term “pick” or “pick'em” refers to a game when neither team is favored in an event or game. “Line”, “cover the spread”, “cover”, “tie”, “pick” and “pick-em” can be integrated into the embodiments in a variety of manners.

To “middle” means to win both sides of a game; wagering on the “underdog” at one point spread and the favorite at a different point spread and winning both sides. For example, if the player bets the underdog +4½ and the favorite −3½ and the favorite wins by 4, the player has middled the book and won both bets. “Middle” can be integrated into the embodiments in a variety of manners.

Digital gaming refers to any type of electronic environment that can be controlled or manipulated by a human user for entertainment purposes. A system that enables a human and a computer to interact according to set of both implicit and explicit rules, in an electronically powered domain for the purpose of recreation or instruction. “eSports” refers to a form of sports competition using video games, or a multiplayer video game played competitively for spectators, typically by professional gamers. Digital gaming and “eSports” can be integrated into the embodiments in a variety of manners.

The term event refers to a form of play, sport, contest, or game, especially one played according to rules and decided by skill, strength, or luck. In some embodiments, an event may be football, hockey, basketball, baseball, golf, tennis, soccer, cricket, rugby, MMA, boxing, swimming, skiing, snowboarding, horse racing, car racing, boat racing, cycling, wrestling, Olympic sport, etc. Event can be integrated into the embodiments in a variety of manners.

The “total” is the combined number of runs, points or goals scored by both teams during the game, including overtime. The “over” refers to a sports bet in which the player wagers that the combined point total of two teams will be more than a specified total. The “under” refers to bets that the total points scored by two teams will be less than a certain figure. “Total”, “over”, and “under” can be integrated into the embodiments in a variety of manners.

A “parlay” is a single bet that links together two or more wagers; to win the bet, the player must win all the wagers in the “parlay”. If the player loses one wager, the player loses the entire bet. However, if he wins all the wagers in the “parlay”, the player wins a higher payoff than if the player had placed the bets separately. A “round robin” is a series of parlays. A “teaser” is a type of parlay in which the point spread, or total of each individual play is adjusted. The price of moving the point spread (teasing) is lower payoff odds on winning wagers. “Parlay”, “round robin”, “teaser” can be integrated into the embodiments in a variety of manners.

A “prop bet” or “proposition bet” means a bet that focuses on the outcome of events within a given game. Props are often offered on marquee games of great interest. These include Sunday and Monday night pro football games, various high-profile college football games, major college bowl games and playoff and championship games. An example of a prop bet is “Which team will score the first touchdown?” “Prop bet” or “proposition bet” can be integrated into the embodiments in a variety of manners.

A “first-half bet” refers to a bet placed on the score in the first half of the event only and only considers the first half of the game or event. The process in which you go about placing this bet is the same process that you would use to place a full game bet, but as previously mentioned, only the first half is important to a first-half bet type of wager. A “half-time bet” refers to a bet placed on scoring in the second half of a game or event only. “First-half-bet” and “half-time-bet” can be integrated into the embodiments in a variety of manners.

A “futures bet” or “future” refers to the odds that are posted well in advance on the winner of major events, typical future bets are the Pro Football Championship, Collegiate Football Championship, the Pro Basketball Championship, the Collegiate Basketball Championship, and the Pro Baseball Championship. “Futures bet” or “future” can be integrated into the embodiments in a variety of manners.

The “listed pitchers” is specific to a baseball bet placed only if both of the pitchers scheduled to start a game actually start. If they don't, the bet is deemed “no action” and refunded. The “run line” in baseball, refers to a spread used instead of the money line. “Listed pitchers” and “no action” and “run line” can be integrated into the embodiments in a variety of manners.

The term “handle” refers to the total amount of bets taken. The term “hold” refers to the percentage the house wins. The term “juice” refers to the bookmaker's commission, most commonly the 11 to 10 bettors lay on straight point spread wagers: also known as “vigorish” or “vig”. The “limit” refers to the maximum amount accepted by the house before the odds and/or point spread are changed. “Off the board” refers to a game in which no bets are being accepted. “Handle”, “juice”, vigorish”, “vig” and “off the board” can be integrated into the embodiments in a variety of manners.

“Casinos” are a public room or building where gambling games are played. “Racino” is a building complex or grounds having a racetrack and gambling facilities for playing slot machines, blackjack, roulette, etc. “Casino” and “Racino” can be integrated into the embodiments in a variety of manners.

Customers are companies, organizations or individual that would deploy, for fees, and may be part of, or perform, various system elements or method steps in the embodiments.

Managed service user interface service is a service that can help customers (1) manage third parties, (2) develop the web, (3) do data analytics, (4) connect thru application program interfaces and (4) track and report on player behaviors. A managed service user interface can be integrated into the embodiments in a variety of manners.

Managed service risk management services are services that assists customers with (1) very important person management, (2) business intelligence, and (3) reporting. These managed service risk management services can be integrated into the embodiments in a variety of manners.

Managed service compliance service is a service that helps customers manage (1) integrity monitoring, (2) play safety, (3) responsible gambling and (4) customer service assistance. These managed service compliance services can be integrated into the embodiments in a variety of manners.

Managed service pricing and trading service is a service that helps customers with (1) official data feeds, (2) data visualization and (3) land based, on property digital signage. These managed service pricing and trading services can be integrated into the embodiments in a variety of manners.

Managed service and technology platform are services that helps customers with (1) web hosting, (2) IT support and (3) player account platform support. These managed service and technology platform services can be integrated into the embodiments in a variety of manners.

Managed service and marketing support services are services that help customers (1) acquire and retain clients and users, (2) provide for bonusing options and (3) develop press release content generation. These managed service and marketing support services can be integrated into the embodiments in a variety of manners.

Payment processing services are those services that help customers that allow for (1) account auditing and (2) withdrawal processing to meet standards for speed and accuracy. Further, these services can provide for integration of global and local payment methods. These payment processing services can be integrated into the embodiments in a variety of manners.

Engaging promotions allow customers to treat your players to free bets, odds boosts, enhanced access and flexible cashback to boost lifetime value. Engaging promotions can be integrated into the embodiments in a variety of manners.

“Cash out” or “pay out” or “payout” allow customers to make available, on singles bets or accumulated bets with a partial cash out where each operator can control payouts by managing commission and availability at all times. The “cash out” or “pay out” or “payout” can be integrated into the embodiments in a variety of manners, including both monetary and non-monetary payouts, such as points, prizes, promotional or discount codes, and the like.

“Customized betting” allow customers to have tailored personalized betting experiences with sophisticated tracking and analysis of players' behavior. “Customized betting” can be integrated into the embodiments in a variety of manners.

Kiosks are devices that offer interactions with customers clients and users with a wide range of modular solutions for both retail and online sports gaming. Kiosks can be integrated into the embodiments in a variety of manners.

Business Applications are an integrated suite of tools for customers to manage the everyday activities that drive sales, profit, and growth, by creating and delivering actionable insights on performance to help customers to manage the sports gaming. Business Applications can be integrated into the embodiments in a variety of manners.

State based integration allows for a given sports gambling game to be modified by states in the United States or other countries, based upon the state the player is in, based upon mobile phone or other geolocation identification means. State based integration can be integrated into the embodiments in a variety of manners.

Game Configurator allow for configuration of customer operators to have the opportunity to apply various chosen or newly created business rules on the game as well as to parametrize risk management. Game configurator can be integrated into the embodiments in a variety of manners.

“Fantasy sports connector” are software connectors between method steps or system elements in the embodiments that can integrate fantasy sports. Fantasy sports allow a competition in which participants select imaginary teams from among the players in a league and score points according to the actual performance of their players. For example, if a player in a fantasy sports is playing at a given real time sports, odds could be changed in the real time sports for that player.

Software as a service (or SaaS) is a method of software delivery and licensing in which software is accessed online via a subscription, rather than bought and installed on individual computers. Software as a service can be integrated into the embodiments in a variety of manners.

Synchronization of screens means synchronizing bets and results between devices, such as TV and mobile, PC and wearables. Synchronization of screens can be integrated into the embodiments in a variety of manners.

Automatic content recognition (ACR) is an identification technology to recognize content played on a media device or present in a media file. Devices containing ACR support enable users to quickly obtain additional information about the content they see without any user-based input or search efforts. To start the recognition, a short media clip (audio, video, or both) is selected. This clip could be selected from within a media file or recorded by a device. Through algorithms such as fingerprinting, information from the actual perceptual content is taken and compared to a database of reference fingerprints, each reference fingerprint corresponding to a known recorded work. A database may contain metadata about the work and associated information, including complementary media. If the fingerprint of the media clip is matched, the identification software returns the corresponding metadata to the client application. For example, during an in-play sports game a “fumble” could be recognized and at the time stamp of the event, metadata such as “fumble” could be displayed. Automatic content recognition (ACR) can be integrated into the embodiments in a variety of manners.

Joining social media means connecting an in-play sports game bet or result to a social media connection, such as a FACEBOOK® chat interaction. Joining social media can be integrated into the embodiments in a variety of manners.

Augmented reality means a technology that superimposes a computer-generated image on a user's view of the real world, thus providing a composite view. In an example of this invention, a real time view of the game can be seen and a “bet” which is a computer-generated data point is placed above the player that is bet on. Augmented reality can be integrated into the embodiments in a variety of manners.

Some embodiments of this disclosure, illustrating all its features, will now be discussed in detail. It can be understood that the embodiments are intended to be open ended in that an item or items used in the embodiments is not meant to be an exhaustive listing of such item or items, or meant to be limited to only the listed item or items.

It can be noted that as used herein and in the appended claims, the singular forms “a,” “an,” and “the” include plural references unless the context clearly dictates otherwise. Although any systems and methods similar or equivalent to those described herein can be used in the practice or testing of embodiments, only some exemplary systems and methods are now described.

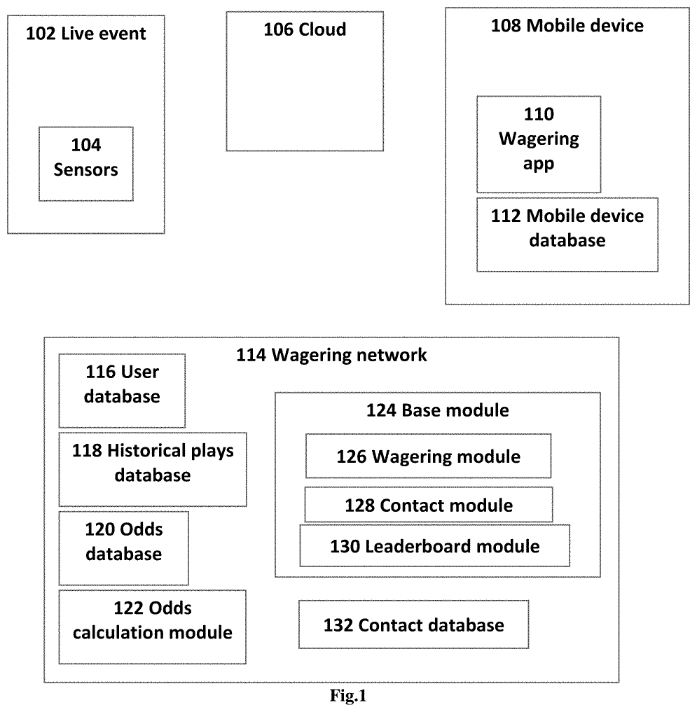

FIG. 1 is a user data comparison system. This system may include a live event 102, for example, a sporting event such as a football game, basketball game, baseball game, hockey game, tennis match, golf tournament, eSports or digital game, etc. The live event 102 may include some number of actions or plays, upon with a user or bettor or customer can place a bet or wager, typically through an entity called a sportsbook. There are numerous types of wagers the bettor can make, including a straight bet, a money line bet, a bet with a point spread or line that the bettor's team would need to cover if the result of the game with the same as the point spread the user would not cover the spread, but instead the tie is called a push. If the user is betting on the favorite, they are giving points to the opposing side, which is the underdog or longshot. Betting on all favorites is referred to as chalk. This is typically applied to round-robin or other tournaments' styles. There are other types of wagers, including parlays, teasers, and prop bets, that are added games that often allow the user to customize their betting by changing the odds and payouts they receive on a wager. Certain sportsbooks will allow the bettor to buy points to move the point spread off of the opening line. This will increase the price of the bet, sometimes by increasing the juice, vig, or hold that the sportsbook takes. Another type of wager the bettor can make is an over/under, in which the user bets over or under a total for the live event 102, such as the score in American football or the run line in baseball, or a series of action in the live event 102. Sportsbooks have several bets they can handle, a limit of wagers they can take on either side of a bet before they will move the line or odds off of the opening line. Additionally, there are circumstances, such as an injury to an important player such as a listed pitcher, in which a sportsbook, casino, or racino will take an available wager off the board. As the line moves there becomes an opportunity for a bettor to bet on both sides at different points spreads to middle, and win, both bets. Sportsbooks will often offer bets on portions of games, such as first-half bets and half-time bets. Additionally, the sportsbook can offer futures bets on live events in the future. Sportsbooks need to offer payment processing services in order to cash out customers. This can be done at kiosks at the live event 102 or at another location.

Further, embodiments may include a plurality of sensors 104 that may be used such as motion sensors, temperature sensors, humidity sensors, cameras such as an RGB-D camera which is a digital camera capable of capturing color (RGB) and depth information for every pixel in an image, microphones, radiofrequency receiver, a thermal imager, a radar device, a lidar device, an ultrasound device, a speaker, wearable devices, etc. Also, the plurality of sensors 104 may include tracking devices, such as RFID tags, GPS chips, or other such devices embedded on uniforms, in equipment, in the field of play, in the boundaries of the field of play, or other markers on the field of play. Imaging devices may also be used as tracking devices such as player tracking that provides statistical information through real-time X, Y positioning of players and X, Y, Z positioning of the ball.

Further, embodiments may include a cloud 106 or a communication network that may be a wired and/or a wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, and other communication techniques that are known in the art. The communication network may allow ubiquitous access to shared pools of configurable system resources and higher-level services that can be rapidly provisioned with minimal management effort, often over the Internet, and relies on sharing of resources to achieve coherence and economies of scale, like a public utility. In contrast, third-party clouds allow organizations to focus on their core businesses instead of expending resources on computer infrastructure and maintenance. The cloud 106 may be communicatively coupled to a peer-to-peer wagering network 114, which may perform real-time analysis on the type of play and the result of the play. The cloud 106 may also be synchronized with game situational data, such as the time of the game, the score, location on the field, weather conditions, and the like, which may affect the choice of play utilized. For example, in other exemplary embodiments, the cloud 106 may not receive data gathered from sensors 104 and may, instead, receive data from an alternative data feed, such as Sports Radar®. This data may be compiled substantially immediately following the completion of any play, and the data from this feed may be compared with a variety of team data and league data based on a variety of elements, including down, possession, score, time, team, and so forth, as described in various exemplary embodiments herein.

Further, embodiments may include a mobile device 108 such as a computing device, laptop, smartphone, tablet, computer, smart speaker, or I/O devices. I/O devices may be present in the computing device. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers. Devices may include a combination of multiple input or output devices, including, e.g., Microsoft KINECT, Nintendo Wii mote for the WIT, Nintendo WII U GAMEPAD, or Apple iPhone. Some devices allow gesture recognition inputs by combining some of the inputs and outputs. Some devices allow for facial recognition, which may be utilized as an input for different purposes, including authentication and other commands. Some devices provide for voice recognition and inputs, including, e.g., Microsoft KINECT, SIRI for iPhone by Apple, Google Now, or Google Voice Search. Additional user devices have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality, including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices, display devices, or group of devices may be augmented reality devices. An I/O controller may control the I/O devices. The I/O controller may control one or more I/O devices, such as e.g., a keyboard and a pointing device, e.g., a mouse or optical pen. Furthermore, an I/O device may also contain storage and/or an installation medium for the computing device. In other embodiments the computing device may include USB connections (not shown) to receive handheld USB storage devices. In further embodiments, an I/O device may be a bridge between the system bus and an external communication bus, e.g., a USB bus, a SCSI bus, a FireWire bus, an Ethernet bus, a Gigabit Ethernet bus, a Fiber Channel bus, or a Thunderbolt bus. In some embodiments, the mobile device 108 could be an optional component and would be utilized in a situation where a paired wearable device utilizes the mobile device 108 as additional memory or computing power or connection to the internet.

Further, embodiments may include a wagering software application or wagering app 110, which is a program that enables the user to place bets on individual plays in the live event 102 and display the audio and video from the live event 102, along with the available wagers on the mobile device 108. The wagering app 110 allows the user to interact with the wagering network 114 to place bets and provide payment/receive funds based on wager outcomes.

Further, embodiments may include a mobile device database 112 which may store some or all of the user's data, the live event 102, or the user's interaction with the wagering network 114.

Further, embodiments may include the wagering network 114, which may perform real-time analysis on the type of play and the result of a play or action. The wagering network 114 (or the cloud 106) may also be synchronized with game situational data, such as the time of the game, the score, location on the field, weather conditions, and the like, which may affect the choice of play utilized. For example, in an exemplary embodiment, the wagering network 114 may not receive data gathered from the sensors 104 and may, instead, receive data from an alternative data feed, such as SportsRadar®. This data may be provided substantially immediately following the completion of any play, and the data from this feed may be compared with a variety of team data and league data based on a variety of elements, including down, possession, score, time, team, and so forth, as described in various exemplary embodiments herein. The wagering network 114 can offer several software as a service managed services such as user interface service, risk management service, compliance, pricing and trading service, IT support of the technology platform, business applications, game configuration, state-based integration, fantasy sports connection, integration to allow the joining of social media, as well as marketing support services that can deliver engaging promotions to the user.

Further, embodiments may include a user database 116, which may contain data relevant to all users of the wagering network 114 and may include, but is not limited to, a user ID, a device identifier, a paired device identifier, wagering history, and wallet information for the user. The user database 116 may also contain a list of user account records associated with a respective user ID. For example, a user account record may include information such as user interests, user personal details such as age, mobile number, etc., sporting events played before, highest wager, favorite sporting event, and current user standings and balance corresponding to the user ID. In addition, the user database 116 may contain betting lines and search queries. The user database 116 may be searched based on a search criterion received from the user. Each betting line may include a plurality of betting attributes such as at least one of the live event 102, a team, a player, an amount of wager, etc. The user database 116 may include information related to all the users involved in the live event 102. In one example embodiment, the user database 116 may include information for generating a user authenticity report and a wagering verification report. Further, the user database 116 may be used to store user statistics like, but not limited to, the retention period for a particular user, frequency of wagers placed by a particular user, the average amount of wager placed by each user.

Further, embodiments may include a historical plays database 118 that may contain play data for the type of sport being played in the live event 102. For example, in American Football, for optimal odds calculation, the historical play data may include metadata about the historical plays, such as time, location, weather, previous plays, opponent, physiological data, etc.

Further, embodiments may utilize an odds database 120 that contains the odds calculated by an odds calculation module 122 to display the odds on the user's mobile device 108 and to take bets from the user through the mobile device wagering app 110.

Further, embodiments may include the odds calculation module 122, which utilizes historical play data to calculate odds for in-play wagers

Further, embodiments may include a base module 124, which may initiate a wagering module 126, a contact module 128, and a leaderboard module 130.

Further, embodiments may include the wagering module 126, which may be triggered when the user places a wager on the live event 102. After receiving the prompt, the module may receive a user selection of the highlighted elements. For example, the user selects the highlighted player, i.e., Aaron Judge of the New York Yankees, playing in the 3rd inning against Clayton Kershaw of the LA dodgers. Further, the wagering module 126 may retrieve available wagers for the selected element. In an embodiment, the wagering module 126 may retrieve available wagers from the odds database 120. In this example, the wagering module 126 retrieves available wagers for Aaron Judge (as a hitter), i.e., a wager on Aaron Judge hitting a single at odds 4/1 and a wager on Aaron Judge hitting a home run at odds 5/1 in the 3rd inning of the match between the New York Yankees and the LA dodgers. Further, the wagering module 126 may display a menu of available wagers related to the selected element. In an embodiment, the menu may be displayed via the wagering app 110 on the display of the mobile device 108. In this example, the wagering module 126 displays a menu of available wagers for Aaron Judge of the New York Yankees hitting against Clayton Kershaw of the LA Dodgers in the 3rd inning of the match. The menu includes a wager on Aaron Judge hitting a single at odds 4/1 and a wager on Aaron Judge hitting a home run at odds 3/1. Further, the wagering module 126 may receive a wager from the user. For example, the user places a wager of $100 on Aaron Judge of the New York Yankees, playing in the 3rd inning against Clayton Kershaw of the LA dodgers, hitting a single at odds 4/1. Further, the wagering module 126 may constantly monitor the live event 102 for completion. In one case, when the live event 102 is concluded, then the wagering module 126 may obtain the results of the live event 102. For example, the result is that Aaron Judge hits a single during the live event 102. In another case, when the live event 102 is not concluded, then the wagering module 126 may continue monitoring the live event 102 for completion. Further, the wagering module 126 may compare the result of the live event 102 with the wagers placed by the user to determine a result, i.e., whether the user has won or lost. In this example, the wager of $100 placed on Aaron Judge of the New York Yankees, playing in the 3rd inning against Clayton Kershaw of the LA dodgers, hitting a single and the result of the live event 102, i.e., Aaron Judge of the New York Yankees, playing in the 3rd inning against Clayton Kershaw of the LA dodgers, hits a single, are compared to determine the result of the wager, i.e., a win for the user. Based on the comparison of the result of the live event 102 and the wagers placed by the user, the wagering module 126 may calculate the balance amount for the user. For example, the user wins the wager of $100 at +400 odds that Aaron Judge will hit a single on the next play, and the result of the live event 102 is Aaron Judge hits a single. Thus, the updated balance of the user (with an opening balance of $2000), after the completion of the live event 102, will be $2000+$400=$2400. Further, the wagering module 126 may update the account balance of the user who places the wager. In this example, after winning the wager of $100 placed (at odds of 4/1), the user's updated balance, i.e., $2400.

Further, embodiments may include the contact module 128, which may be executed by the base module 124 once a user executes an icon on the mobile device 108. This module requests inputs from the user for friends of the user. This request can be made by entering in the friend's contact information. It may be understood to those of ordinary skill in the art that there are many ways to get a friend's contact information. For instance, but not limited to, friends submitting an invite to a friend via a link from the wagering network 114 to allow inputting in contacts information; Searching through a list of contacts, and once selected, allowing the friend to approve being on the list; Etc. Once the friend contact information is received, it is stored in a contact database 132.

Further, embodiments may include the leaderboard module 130, which may be executed by the base module 124. During the current play of the live event 102, the module searches the contact database 132 for the user's friends. The leaderboard module 130 then extracts for each friend the historical bets for each game user's friends from the user database 116. The leaderboard module 130 module calculates (at the beginning of each new play event) the performance differences between the user and each friend. These performance differences could be, for example, but not limited to, the total % of wins to losses, the total amount bet and the total amount net won or lost, the best streak (consecutive wins), the biggest single win, the biggest single loss, etc. The performance differences may be limited to a subset of past data. For example, but not limited to, the current games time windows (e.g., inning (baseball) or quarter (football), the entire game, the last ten games, the entire history, a subset selected by the user, etc.

Further, embodiments may include the contact database 132 which may store, for each user, their friends that have been selected to be on their friends list. This database may store the performance metrics by time and by play so that all the performance metrics can later be shown on a leaderboard.

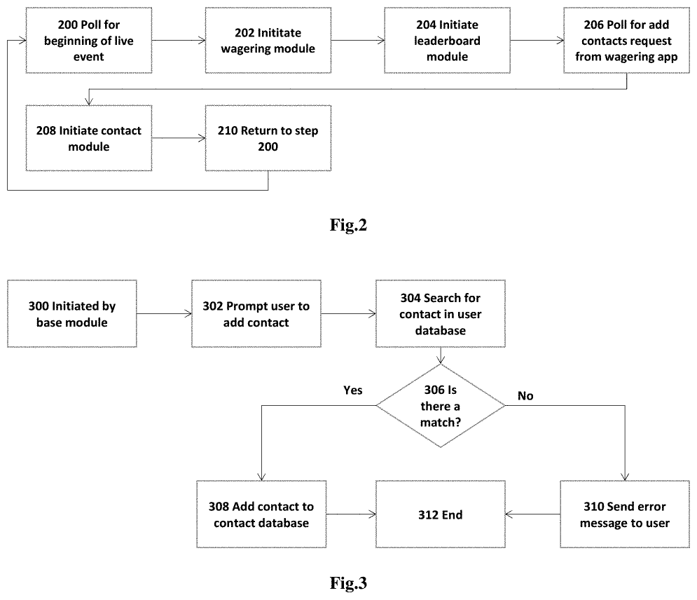

FIG. 2 illustrates the base module 124. The process begins with the base module 124 polling, at step 200, for the beginning of the live event 102. The start of the live event 102 may be determined using data from the sensors 104 of the live event 102. The base module 124 initiates, at step 202, the wagering module 126. The base module 124 initiates, at step 204, the leaderboard module 130. The base module 124 polls, at step 206, for a request from the wagering app 110 to add a new contact. This request may be sent from the mobile device 108 by the user. For example, the user may press an “add contact” button. The base module 124 initiates, at step 208, the contact module 128. The base module 124 returns, at step 210, to step 200.

FIG. 3 illustrates the contact module 128. The process begins with the contact module 128 being initiated, at step 300, by the base module 124. The base module 124 may be prompted to initiate the contact module 128 after the user selects to add contacts from the mobile device 108. The contact module 128 prompts, at step 302, the user to add a contact. The user may add a contact by entering the user ID of the contact. The user may add a contact with another identifier, for example, the user's name, if the identifier is stored in the user database 116. The contact module 128 searches, at step 304, for a matching user ID, or another identifier, in the user database 116. The contact module 128 determines, at step 306, if there is a matching entry in the user database 116. If there is a matching entry, the contact module 128 adds, at step 308, the matching entry user ID to the contact database 132. The user ID of the contact is stored as the “contact user ID” and associated with the user ID of the user adding the contact. If there is no matching entry, the contact module 128 sends, at step 310, a notification to the mobile device 108 that no contact with that user ID, or other identifiers, has been found. The contact module 128 may return to step 302. The contact module 128 ends at step 312.

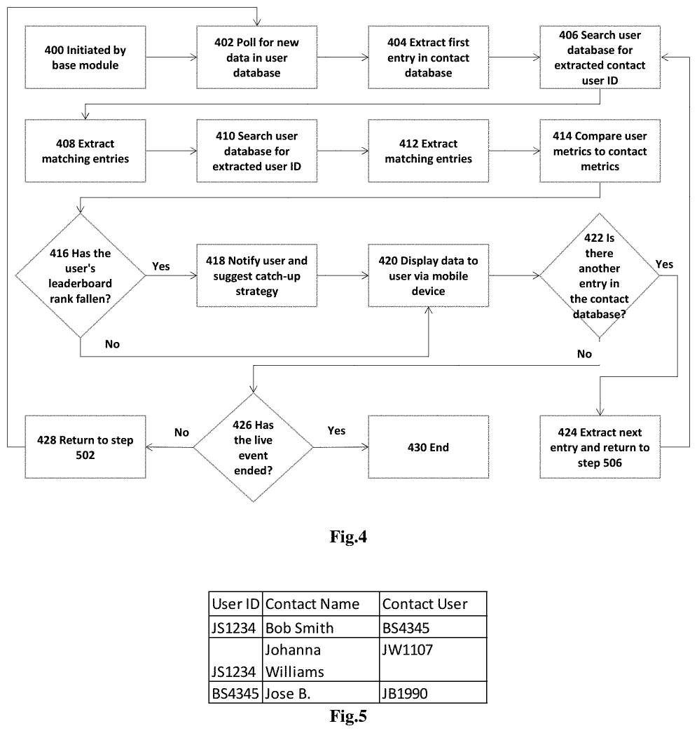

FIG. 4 illustrates the leaderboard module 130. The process begins with the leaderboard module 130 being, at step 400, initiated by the base module 124. The leaderboard module 130 polls, at step 402, for a new data entry in the user database 116. A new data entry may be a wager that has been placed or a wager that was resolved. This may cause the leaderboard module 130 to update when new data is available. The leaderboard module 130 extracts, at step 404, the first entry in the contact database 132. This entry may contain a user ID and a contact ID. The user ID will be used to obtain the user's wager data, and the contact ID will be used to obtain the contact's wager data. The leaderboard module 130 may only extract entries with user IDs of active users. The leaderboard module 130 searches, at step 406, the user database 116 for a user ID that matches the contact user ID extracted from the contract database 130. Identifying a match will return all data on the contact that is stored in the user database 116. Entries that are not relevant to past wager data may be ignored. The leaderboard module 130 extracts, at step 408, all matching entries from the user database 116. The extracted entries may be limited to a subset of past data, for example, but not limited to, the current games time windows (e.g., inning (baseball) or quarter (football), the entire game, the last ten games, a subset selected by the user, etc. The leaderboard module 130 searches, at step 410, the user database 116 for a user ID that matches the contact user ID extracted from the contract database 130. Identifying a match will return all data on the user stored in the user database 116. Entries that are not relevant to past wager data may be ignored. The leaderboard module 130 extracts, at step 412, all matching entries from the user database 116. The extracted entries may be limited to a subset of past data. For example, but not limited to the current games time windows (e.g., inning (baseball) or quarter (football), the entire game, the last ten games, a subset selected by the user, etc. The leaderboard module 130 compares, at step 414, metrics for the user to metrics for each of the user's contacts. If there are multiple entries for a metric, the values may be combined. The term combination may be interpreted as any method of merging all similar data in a more digestible form to a user, for example, but not limited to, the total % of wins to losses, the total amount bet, the total amount net won or lost, the best streak (consecutive wins), the biggest single win, the biggest single loss, etc. The user may be assigned a leaderboard rank. For example, if the user has a win rate of 44%, and the user's five contacts have win rates of 48%, 49%, 42%, 44%, and 49%, then the user will have a leaderboard ranking of 3rd. The leaderboard module 130 determines, at step 416, if the user's leaderboard rank has fallen compared to the last time the leaderboard module 130 executed this step. The user's previous leaderboard rank may be stored in a database. If the user's leaderboard rank has fallen, the leaderboard module 130 notifies, at step 418, the user. The notification may be sent to the mobile device 108. The notification may include a message that informs the user that their position on the leaderboard has fallen. The notification may also include suggestions on how the user may reclaim their position on the leaderboard. For example, if the user has fallen in rank on the leaderboard for the largest win, the notification may include which bet option to choose and how much to wager in order to have a chance at reclaiming their rank. The leaderboard module 130 displays, at step 420, the combined data to the user that corresponds to the user ID extracted from the contact database 132. This data may be displayed via the mobile device 108. For example, a user may be able to see the top 10 highest winnings contacts, the top 40 highest win rate contacts, the top 4 net winnings contacts within a 40-mile radius, etc. The user may be able to view the display via the mobile device 108. The user may be able to change how the contacts are displayed. The display may be refreshed when there is new data. The leaderboard module 130 determines, at step 422, if there is another entry in the contact database 132. If there is another entry in the contact database 132, the leaderboard module 130 extracts, at step 424, the next entry and returns to step 406. If there is not another entry in the contact database 132, the leaderboard module 130 determines, at step 426, if the live event 102 has ended. The end of the live event 102 may be determined using data from the sensors 104 of the live event 102. If the live event 102 has not ended, the leaderboard module 130 returns, at step 428, to step 402. If the live event 102 has ended, the leaderboard module 130 ends at step 430.

FIG. 5 illustrates the contact database 132. The contact database 132 may contain user IDs, for example, JS1234. The database may also contain the names of the user's contacts associated with the user ID, for example, “Bob Smith.” The database may also contain the user ID associated with the contact, for example, BS4345.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method for comparing user data in a sports wagering application, comprising:
storing wagers from a sports wagering application in a database;
storing one or more contacts for each of a plurality of users of the sports wagering application in the database;
polling the database for wagers made by the plurality of users;
comparing metrics of wagers of at least a first user and at least a second user among the plurality of users;
assigning a rank to the at least first user and the at least second user on a leaderboard based on the comparison of metrics; and
notifying the at least first user of a change in rank on the leaderboard.

2. The method for comparing user data in a sports wagering application of claim 1, further comprising automatically generating and providing the at least first user with a notification with wager information to advance in rank on the leaderboard.

3. The method for comparing user data in a sports wagering application of claim 1, wherein the polled wagers are limited to wagers placed during a current live action game.

4. The method for comparing user data in a sports wagering application of claim 3, wherein the polled wagers are limited to a defined subset of the live action game.

5. The method for comparing user data in a sports wagering application of claim 1, further comprising displaying the leaderboard to the at least one user.

6. The method for comparing user data in a sports wagering application of claim 1, wherein the leaderboard comprises a listing of users among the plurality of users within a defined geographic space.

7. The method for comparing user data in a sports wagering application of claim 1, wherein the wagering network is a play by play wagering network and the ranks are assigned during a live sporting event upon which play by play wagers are being made.

8. A method for providing a leaderboard for a live action game wagering system, comprising:
displaying a wagering application;
displaying one or more contacts of a user that use the wagering application;
displaying one or more wagers associated with a live action game;
displaying results of a wager placed by the user in the wagering application; and
displaying a leaderboard, wherein the leaderboard is determined by at least the results of the wager placed by the user and results of a wager placed by at least one or more of the contacts.

9. The method for providing a leaderboard for a live action game wagering system of claim 8, further comprising displaying a notification to the user of a change in position on the leaderboard for the user.

10. The method for providing a leaderboard for a live action game wagering system of claim 9, further comprising displaying a notification to the user of a wager to reclaim a lost position on the leaderboard.

11. The method for providing a leaderboard for a live action game wagering system of claim 8, further wherein the wagering system is a play by play wagering system and the wagers are placed on play by play action in the live sporting event.
